(19) United States
(12) Patent Application Publication
(10) Pub. No.: US 2008/0154822 A1
(43) Pub. Date: Jun. 26, 2008

(54) Systems and methods for creating an artificial neural network

(75) Inventors: Daniel Curt Loeser, Baltimore, MD (US); David Edward Maestas, Lake Saint Louis, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: TechGuard Security LLC

(21) Appl. No.: 11/589,539

(22) Filed: Oct. 30, 2006

(51) Int. Cl. G06E 1/00

(52) U.S. Cl. 706/26

(57) ABSTRACT

A neural network system is described. The neural network system includes an artificial neural network including a plurality of neurons. One of the neurons includes an analog electrical circuit and the neurons are interconnected.

### BACKGROUND OF THE INVENTION

This invention relates generally to an artificial neural network and more particularly to systems and methods for creating the artificial neural network.

Over the last few decades, artificial neural networks have found to be useful in a plurality of areas where “fuzzy” decisions are made. Despite some successes under laboratory conditions, an actual deployment of the artificial neural networks has been rather slow, due largely to an amount of computing power used to perform math at practical speeds. Moreover, the artificial neural networks are costly, slow, and used a lot of space.

### BRIEF DESCRIPTION OF THE INVENTION

In one aspect, a neural network system is described. The neural network system includes an artificial neural network including a plurality of neurons. One of the neurons includes an analog electrical circuit and the neurons are interconnected.

In another aspect, a neuron is described. The neuron includes an analog electrical circuit.

In yet another aspect, a method is described. The method includes generating an artificial neural network including a plurality of neurons interconnected to each other. One of the neurons includes an analog electrical circuit.

In still another aspect, a processor executing a computer program is described. The processor is configured to receive a topography of an artificial neural network, receive a weight of a neuron within the artificial neural network, and generate a plurality of parameters based on the weight and the topography.

In another aspect, a processor for executing a computer program is described. The processor is configured to receive a training neural input and receive a training neural output. The processor is further configured to calculate a topography of an artificial neural network, a weight of the artificial neural network, and a plurality of parameters of the artificial neural network from the training neural input and the training neural output.

### BRIEF DESCRIPTION OF THE DRAWINGS

FIG. 1 is a block diagram of an embodiment of an artificial neural network system.

FIG. 2 is a block diagram of an embodiment of a neuron of the neural network system of FIG. 1.

FIG. 3 is a circuit diagram of an embodiment of a summation system of the neuron of FIG. 2.

FIG. 4 is a circuit diagram of an embodiment of a nonlinear transfer system of the neuron of FIG. 2.

FIG. 5 is an embodiment of a graph representing a relation between a nonlinear transfer system input signal and an analog signal at a node within the nonlinear transfer system of FIG. 4.

FIG. 6 is a circuit diagram of an embodiment of a non-inverting buffer that can be included within the neuron of FIG. 2.

FIG. 7 is a circuit diagram of an embodiment of an inverting buffer that can be included within the neuron of FIG. 2.

FIG. 8 is a circuit diagram of an embodiment of a non-inverting amplifier that can be included within the neuron of FIG. 2.

FIG. 9 is a circuit diagram of an embodiment of an inverting amplifier that can be included within the neuron of FIG. 2.

FIG. 10 is a circuit diagram of an embodiment of a voltage divider and a non-inverting buffer (VDNB) that can be included within the neuron of FIG. 2.

FIG. 11 is a circuit diagram of an embodiment of a voltage divider and an inverting buffer (VDIB) that can be included within the neuron of FIG. 2.

FIG. 12 is a circuit diagram of an embodiment of an operational amplifier that is included within the neuron of FIG. 2.

FIG. 13 is a circuit diagram of another embodiment of an artificial neural network system.

FIG. 14 is a diagram of an embodiment of a system for generating a plurality of parameters of the artificial neural network system of FIG. 1.

### DETAILED DESCRIPTION OF THE INVENTION

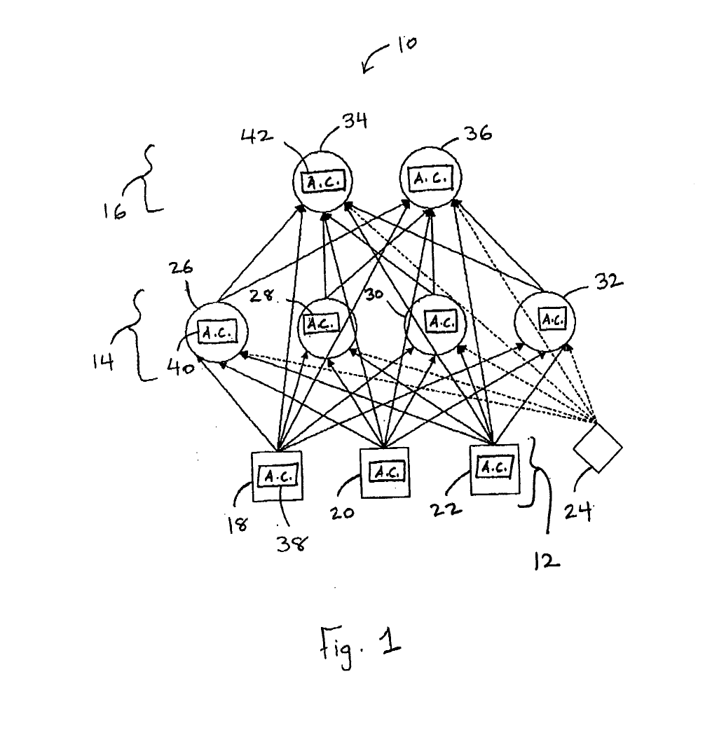

FIG. 1 is a block diagram of an embodiment of an artificial neural network system 10. Artificial neural network system 10, which is a feed forward network, includes a neural input layer 12, a neural hidden layer 14, a neural output layer 16, and a set 24 of biases. An example of each bias of set 24 includes a voltage source, a power source, and a current source. Neural input layer 12 includes a plurality of neurons 18, 20, and 22. Neural hidden layer 14 includes a plurality of neurons 26, 28, 30, and 32. Moreover, neural output layer 16 includes a plurality of neurons 34 and 36. Each neuron 18, 20, 22, 26, 28, 30, 32, 34, and 36 includes an analog circuit (A.C.). For example, neuron 18 includes an analog circuit 38, neuron 26 includes an analog circuit 40, and neuron 34 includes an analog circuit 42.

A neuron receives at least one input from at least one neuron and provides at least one output based on the at least one input and a bias within set 24 of biases. For example, neuron 26 receives a plurality of inputs from neurons 18 and 20, and a bias within set 24 of biases, and provides a plurality of outputs to neurons 34 and 36 based on the inputs and a bias within set 24 of biases.

In an embodiment, a different bias is provided to at least one neuron of artificial neural network system 10 than a bias provided to the remaining neurons of artificial neural network system 10. For example, a bias of 2 is provided to neuron 26 and a bias of 1 is provided to neuron 42. In another embodiment, the same bias is provided to each neuron of artificial neural network system 10. For example, a bias of 3 is provided to each of neurons 18, 20, 22, 26, 28, 30, 32, 34, and 36. In another embodiment, neural input layer 12 includes any number, such as 1, 2, 5, or 10, neurons, neural hidden layer 14 includes any number, such as 1, 2, 3, or 20, neurons, and neural output layer 16 includes any number, such as 1, 3, 5, or 10, neurons. In yet another embodiment, at least one of neurons 18, 20, 22, 26, 28, 30, 32, 34, and 36 includes an analog circuit and the remaining of neurons 18, 20, 22, 24, 26, 28, 30, 32, 34, and 36 includes a digital circuit. For example, neuron 26 of neural hidden layer 14 does not include analog circuit 40 and instead includes a processor. As used herein, the term processor is not limited to just those integrated circuits referred to in the art as a processor, but broadly refers to a computer, a microcontroller, a microcomputer, a programmable logic controller, an application specific integrated circuit, and any other programmable circuit. In still another embodiment, each neuron 18, 20, and 22 of neural input layer 12 does not include a summation system and a nonlinear transfer system, and each neuron 18, 20, and 22 of neural input layer 12 includes a weight. In another embodiment, artificial neural network system 10 includes any number, such as 2, 3, 5, or 10, of neural hidden layers 14.

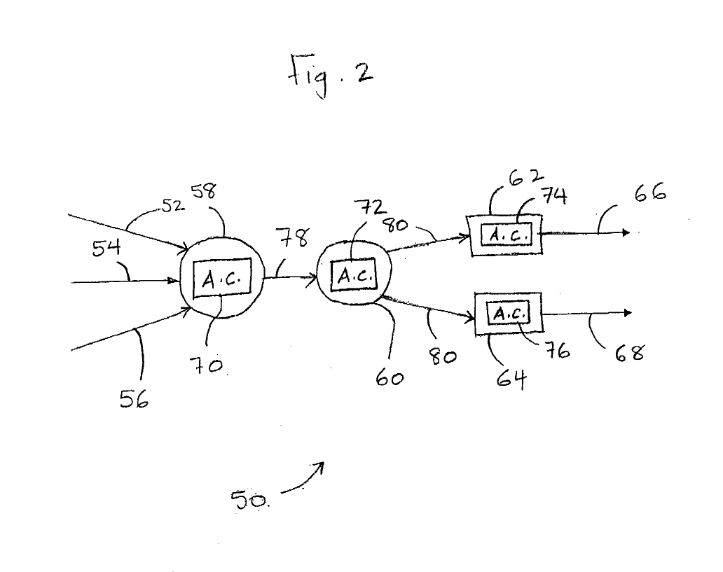

FIG. 2 is a block diagram of an embodiment of a neuron 50. Neuron 50 is an example of any of neurons 18, 20, 22, 26, 28, 30, 32, 34, and 36. Neuron 50 is an artificial neuron that represents a neuron of a brain of a user or person. Neuron 50 includes a plurality of neural inputs 52, 54, and a bias signal 56, which is output from a bias within set 24 of biases. Bias signal 56 is an analog signal, such as an analog electrical voltage signal or an analog electrical current signal. Neuron 50 further includes a summation system 58, a nonlinear transfer system 60, a plurality of weights 62 and 64, and a plurality of neural outputs 66 and 68. Weight 62 has a different value from weight 64 at a particular time. Summation system 58 includes an analog circuit 70, nonlinear transfer function system 60 includes an analog circuit 72, weight 62 includes an analog circuit 74, and weight 64 includes an analog circuit 76.

Each neural input 52 and 54 is an analog signal and each neural output 66 and 68 is an analog signal. For example, neural input 52 can be generated by an oscillator that generates an alternating current level signal. As another example, neural input 52 of neuron 50 can be a neural output or an analog signal output by another neuron. In the example, neural input 52 is equal to the neural output of the other neuron. Neural output 66 of neuron 50 can be a neural input of an additional neuron. An analog signal, as used herein, is other than a digital signal and does not include bits 0 and 1. As used herein, an analog signal is a signal that is not quantized into discrete values, such as binary digits. As used herein, an analog signal is a continuous signal having a voltage level, a current level, and a signal frequency. Examples of nonlinear transfer system 60 include a system generating a nonlinear transfer function, such as a step function, a sine function, a cosine function, or a hyperbolic function. Examples of the hyperbolic function include a hyperbolic tangent function, a hyperbolic sine function, and a hyperbolic cosine function.

Summation system 58 receives neural inputs 52 and 54, and bias signal 56, sums the inputs 52, 54, and bias signal 56 to output a summation system output signal 78, which is an analog signal. Nonlinear transfer system 60 receives summation system output signal 78 and applies a nonlinear function to summation system output signal 78 to generate a plurality of identical nonlinear transfer system output signals 80, which are analog signals. Weight 62 receives nonlinear transfer system output signal 80 and provides a weight to nonlinear transfer system output signal 80 to output neural output 66. Similarly, weight 64 receives nonlinear transfer system output signal 80 and provides a weight to nonlinear transfer system output signal 80 to output neural output 68. It is noted that the number of neural outputs 66 and 68 is equal to the number of nonlinear transfer system output signals 80.

Neuron 50 is trained by backpropagation. As an example, the backpropagation includes supplying neural input 52 to neuron 50, determining neural output 66 based on neural input 52, comparing neural output 66 with an ideal neural output, and adjusting weight so that neural output 66 is within a tolerance of the ideal neural output.

It is noted that in one embodiment, at least one of summation system 58, nonlinear transfer function system 60, weight 62, and weight 64 includes an analog circuit and the remaining of summation system 58, nonlinear transfer function system 60, weight 62, and weight 64 includes a digital circuit. For example, weight 62 does not include analog circuit 74 and nonlinear transfer function system 60 does not include analog circuit 72. In the example, weight 62 includes a processor and nonlinear transfer function system 60 includes a processor. As another example, weight 62 includes analog circuit 74, nonlinear transfer system 60 includes analog circuit 72, summation system 58 includes analog circuit 70, and weight 64 includes a digital circuit. In another embodiment, neuron 50 includes any number, such as 1, 3, 5, 100, or 1000, of neural inputs, any number, such as 1, 3, 5, or 10, of neural outputs, and any number, such as 1, 3, 5, 10, or 100, of weights.

FIG. 3 is a circuit diagram of an embodiment of summation system 100, which is an example of analog circuit 70 of summation system 58. Summation system 100 includes a non-inverting amplifier 102 electrically connected to a plurality of neural inputs 104, 106, 108, and 110, and a plurality of resistors 112, 114, 116, and 118. Each resistor 112, 114, 116, and 118 has the same resistance, such as 1 kilo ohm (k) or 10 k. Neural input 104 is an example of neural input 52 and neural input 106 is an example of neural input 54. Neural input 108 is an example of bias signal 56. Non-inverting amplifier 102 includes an operational amplifier 120, such as an LT 1001 available from Linear Technology™ Corporation or an LT 1055 amplifier available from Linear Technology™ corporation, and a plurality of resistors 122 and 124. A power supply, such as a voltage source, supplies a positive voltage level Vₐ to operational amplifier 120 and a power supply, such as a voltage source, supplies a negative voltage level −V_{b} to operational amplifier 120.

Summation system 100 receives neural inputs 104, 106, 108, and 110 to generate an analog signal at a point 126. Non-inverting amplifier 102 receives the analog signal at point 126 and provides a gain to the analog signal to output an analog signal 128, which is an example of summation system output signal 78. As an example, the gain of non-inverting amplifier 102 is represented as

voltage level of analog signal 128/voltage level at point 126=1+(resistance of resistor 122)/(resistance of resistor 124) . . . (1)

The user creates summation system 100 so that the gain of non-inverting amplifier 102 is equal to a number of neural inputs 104, 106, 109, and 110. For example, the gain of non-inverting amplifier 102 is (3 k/1 k)+1=4 when resistor 122 has a resistance of 3 k and resistor 124 has a resistance of 1 k.

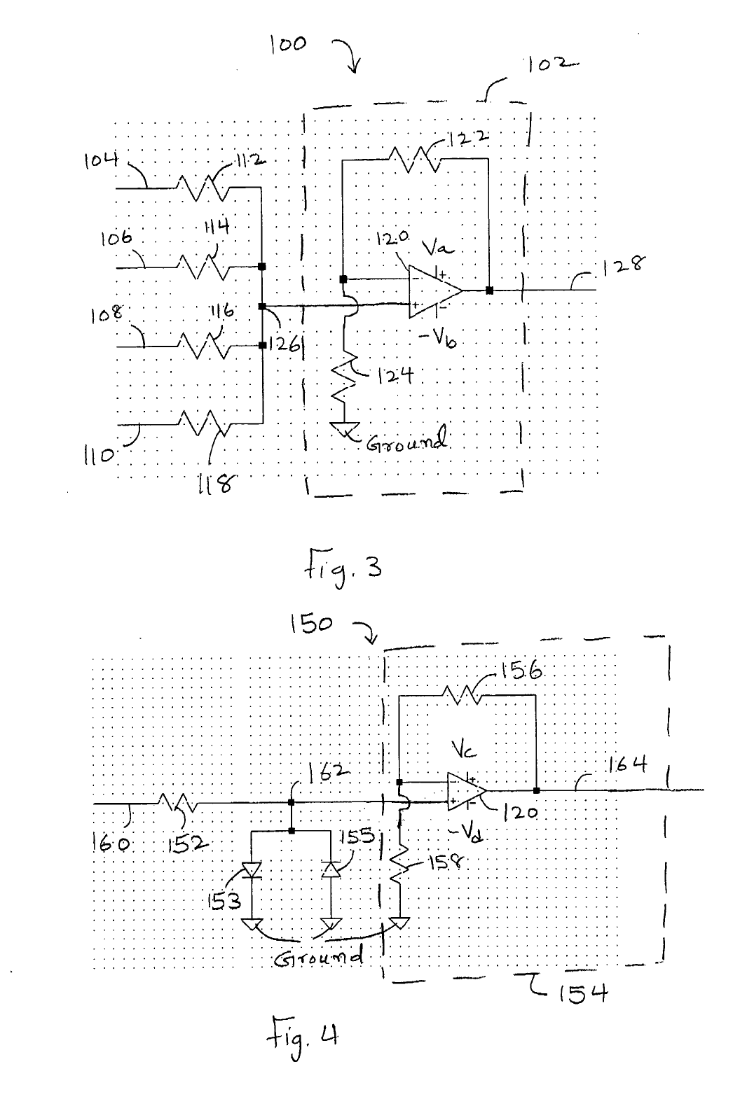

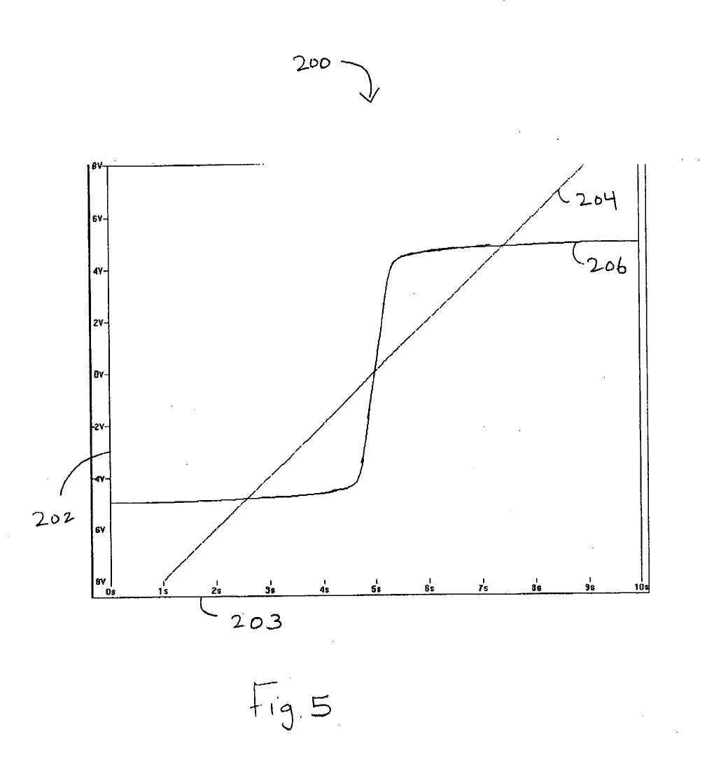

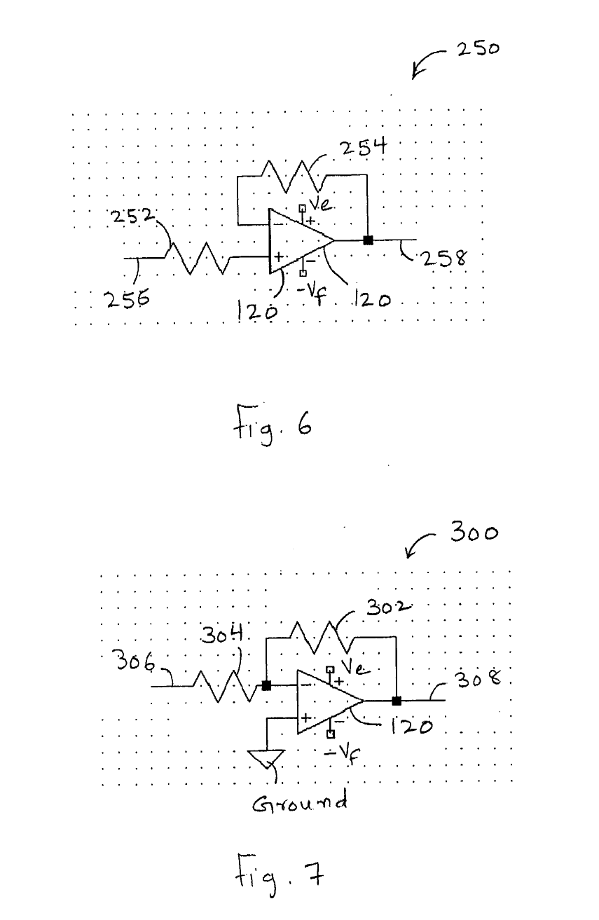

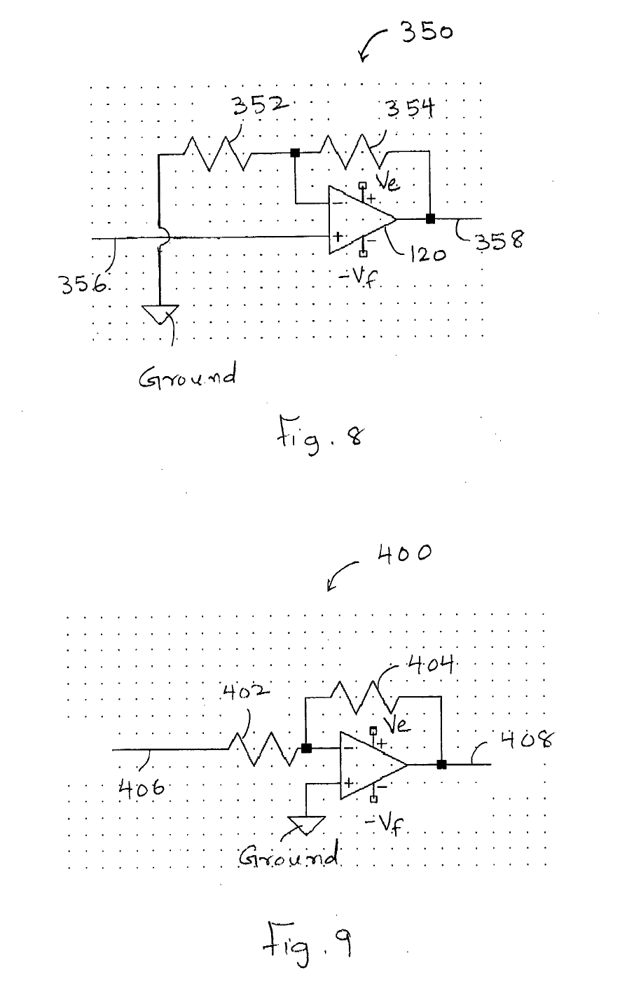

FIG. 4 is a circuit diagram of an embodiment of a nonlinear transfer system 150, which is an example of analog circuit 72 of nonlinear transfer system 60. Nonlinear transfer system 150 includes a resistor 152 having a resistance, such as 1 k or 2 k, a plurality of diodes 153 and 155, and a non-inverting amplifier 154. Non-inverting amplifier 154 includes a plurality of resistors 156 and 158, and operational amplifier 120. As an example, resistor 156 has a resistance of 60 k and resistor 158 has a resistance of 10 k. As another example, resistor 156 has a resistance of 70 k and resistor 158 has a resistance of 20 k. If a nonlinear transfer system input signal 160, which is an example of summation system output signal 78 or of analog signal 128, linearly varies with respect to time, an analog signal at a node 162 follows a shape of a hyperbolic tangent. A power supply, such as a voltage source, supplies a positive voltage level V_{c} to operational amplifier 120 of nonlinear transfer system 150 and a power supply, such as a voltage source, supplies a negative voltage level −V_{d} to operational amplifier 120 of nonlinear transfer system 150. As an example Vₐ=V_{c} and −V_{b}=−V_{d}.

In nonlinear transfer system 150, diode 153 is turned on when diode 155 is turned off and diode 155 is turned on when diode 153 is turned off. Nonlinear transfer system 150 receives nonlinear transfer system input signal 160 to generate the analog signal at node 162. Non-inverting amplifier 102 receives the analog signal at node 162 and provides a gain to the analog signal to output a nonlinear transfer system output signal 164, which is an example of nonlinear transfer system output signal 80. For example, the gain provided by non-inverting amplifier 102 is represented as

voltage level of nonlinear transfer system output signal 164/voltage level at node 162=1+(a resistance of resistor 156/a resistance of resistor 158) . . . (2).

FIG. 5 is an embodiment of a graph 200 representing a relation between nonlinear transfer system input signal 160 and the analog signal at node 162. A voltage level is plotted on an ordinate 202 and time is plotted on an abscissa 203. A plurality of analog signals 204 and 206 are plotted on graph 200. Signal 204 is an example of nonlinear transfer system input signal 160 and signal 206 is an example of the analog signal at node 162. It is noted that signal 206 has a shape of a hyperbolic tangent when signal 204 is linear.

FIG. 6 is a circuit diagram of an embodiment of a non-inverting buffer 250, which is an example of any of analog circuits 74 and 76. Non-inverting buffer 250 includes a resistor 252, a resistor 254, and operational amplifier 120. Each of resistors 252 and 254 has the same resistance, such as 500 ohms or 700 ohms. For example, resistor 252 has a resistance of 400 ohms and resistor 254 has a resistance of 400 ohms. Operational amplifier 120 of non-inverting buffer 250 receives a power, such as a voltage level Vₑ, from a power source, such as a voltage source. Moreover, operational amplifier 120 of non-inverting buffer 250 receives a power, such as a negative voltage level −V_{f}, from a power source, such as s voltage source.

Non-inverting buffer 250 receives a non-inverting buffer input signal 256, which is an example of any of nonlinear transfer output signals 80, and provides a gain of 1, represented as a weight W=1, to non-inverting buffer input signal 256 to output a non-inverting buffer output signal 258, which is an example of any of neural outputs 66 and 68. A ratio of non-inverting buffer output signal 258 to non-inverting buffer input signal 256 is equal to the gain of non-inverting buffer 250. When operational amplifier 120 is used within non-inverting buffer 250, a significant level of current does not flow from an input of non-inverting buffer 250 to an output of non-inverting buffer 250.

FIG. 7 is a circuit diagram of an embodiment of an inverting buffer 300, which is an example of any of analog circuits 74 and 76. Inverting buffer 300 includes a plurality of resistors 302 and 304, and operational amplifier 120. Each resistor 302 and 304 has the same resistance, such as 10 k or 5 k. For example, resistor 302 has a resistance of 8 k and resistor 304 has a resistance of 8 k.

Inverting buffer 300 receives an inverting buffer input signal 306, which is an example of any of nonlinear transfer system output signals 80 and provides a gain of −1, represented as W=−1, to inverting buffer input signal 306 to generate an inverting buffer output signal 308, which is an example of any of neural outputs 66 and 68. A ratio of inverting buffer output signal 308 to inverting buffer input signal 306 is equal to the gain of inverting buffer 300. When operational amplifier 120 is included within inverting buffer 300, a significant amount of current level does not flow from an input of inverting buffer 300 to an output of inverting buffer 300.

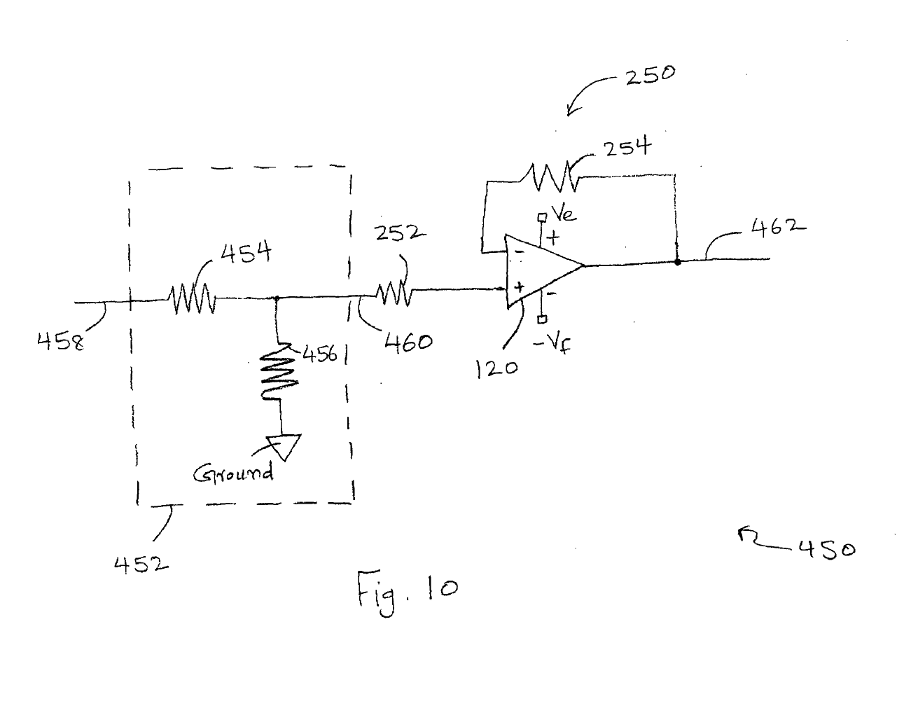

FIG. 8 is a circuit diagram of an embodiment of a non-inverting amplifier 350, which is an example of any of analog circuits 74 and 76. Non-inverting amplifier 350 includes operational amplifier 120, and a plurality of resistors 352 and 354.

Non-inverting amplifier 350 receives a non-inverting amplifier input signal 356, which is an example of any of nonlinear transfer system output signals 80, provides a gain greater than 1, represented as W>1, to non-inverting amplifier input signal 356 to output a non-inverting amplifier output signal 358, which is an example of any of neural outputs 66 and 68. A ratio of non-inverting amplifier output signal 358 to non-inverting amplifier input signal 356 is equal to the gain of non-inverting amplifier 350. The gain of non-inverting amplifier 350 is provided as

non-inverting amplifier output signal 358/non-inverting amplifier input signal 356=1+(resistance of resistor 354)/(resistance of resistor 352) . . . (3)

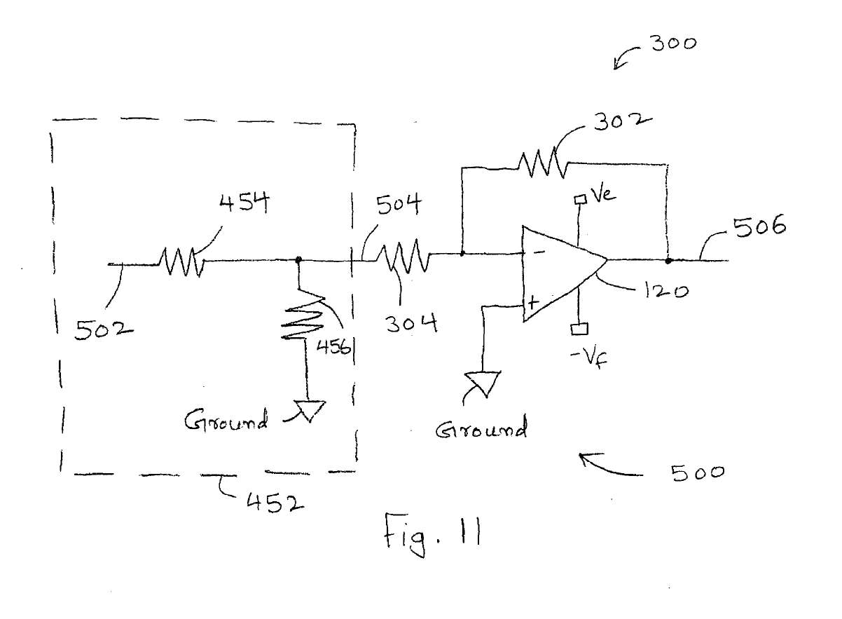

FIG. 9 is a circuit diagram of an embodiment of an inverting amplifier 400, which is an example of any of analog circuits 74 and 76. Inverting amplifier 400 includes a plurality of resistors 402 and 404, and operational amplifier 120.

Inverting amplifier 400 receives an inverting amplifier input signal 406, which is an example of any of nonlinear transfer system output signals 80, and provides a gain less than −1, represented as W<−1, to the inverting amplifier input signal 406 to output an inverting amplifier output signal 408, which is an example of any of neural outputs 66 and 68. The gain of inverting amplifier 400 is represented as

Inverting amplifier output signal 408/inverting amplifier input signal 406=−(resistance of resistor 404)/(resistance of resistor 402) . . . (4)

FIG. 10 is a circuit diagram of an embodiment of a voltage divider and a non-inverting buffer (VDNB) 450, which is an example of any of analog circuits 74 and 76. VDNB 450 includes non-inverting buffer 250 that is electrically connected to a voltage divider 452. Voltage divider 452 includes a plurality of resistors 454 and 456. Voltage divider 452 receives a VDNB input signal 458, which is an example of any of nonlinear transfer system output signals 80, and provides a gain to VDNB input signal 458 to output a voltage divider output signal 460. The gain of voltage divider 452 is provided as

resistance of resistor 456/(resistance of resistor 456+resistance of resistor 454)=voltage divider output signal 460/VDNB input signal 458 . . . (5)

Non-inverting buffer 250 receives voltage divider output signal 460, and provides the gain of non-inverting buffer 250 to voltage divider output signal 460 to output a VDNB output signal 462, which is an example of any of neural outputs 66 and 68. A gain provided by VDNB 450 to VDNB input signal 458 is a product of the gain of voltage divider 452 and the gain of non-inverting buffer 250. The gain provided by VDNB 450 to VDNB input signal 458 is greater than 0 and less than 1, represented as 0<W<1.

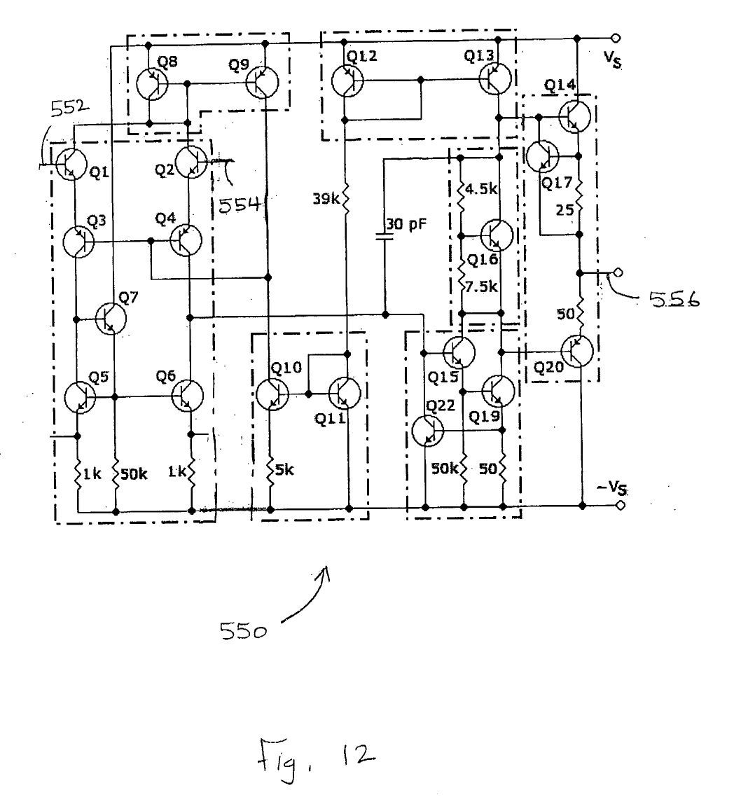

FIG. 11 is a circuit diagram of an embodiment of a voltage divider and an inverting buffer (VDIB) 500, which is an example of any of analog circuits 74 and 76. VDIB 500 includes inverting buffer 300 that is electrically connected to voltage divider 452. Voltage divider 452 receives a VDIB input signal 502, which is an example of any of nonlinear transfer system output signals 80, and provides a gain to VDIB input signal 502 to output a voltage divider output signal 504. The gain of voltage divider 452 is provided as

resistance of resistor 456/(Resistance of resistor 456+resistance of resistor 454)=voltage divider output signal 504/VDIB input signal 502 . . . (6)

Inverting buffer 300 receives voltage divider output signal 504, and provides the gain of inverting buffer 300 to voltage divider output signal 504 to output a VDIB output signal 506, which is an example of any of neural outputs 66 and 68. A gain provided by VDIB 500 to VDIB input signal 502 is a product of the gain of voltage divider 452 and the gain of inverting buffer 300. The gain provided by VDIB 500 to VDIB input signal 502 is less than 0 and greater than −1, represented as −1<W<0.

It is noted that any two components of neuron 50 are electrically connected by a conductor, such as a wire or a copper wire. For example, nonlinear transfer system 60 is connected via a conductor to summation system 58. As another example, operational amplifier 120 is electrically connected to resistor 152 via a conductor. As yet another example, nonlinear transfer system 72 is connected to any of weights 62 and 64 via a conductor.

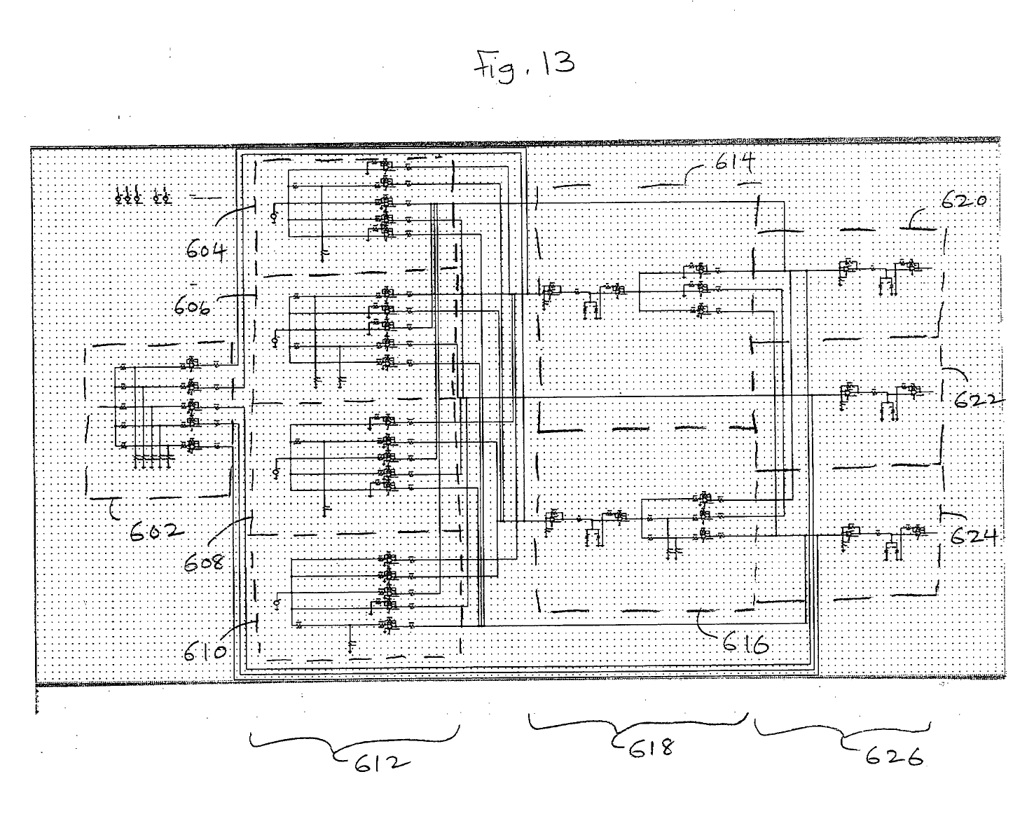

FIG. 12 is a circuit diagram of an embodiment of an operational amplifier 550, which is a 741 operational amplifier and is an example of operational amplifier 120. Operational amplifier 550 includes a plurality of transistors, such as a bipolar junction transistor (BJT) Q1, Q2, Q3, Q4, Q5, Q6, Q7, Q8, Q9, Q10, Q11, Q12, Q13, Q14, Q15, Q16, Q17, Q18, Q19, Q20, Q21, and Q22.

Operational amplifier 120 receives a non-inverting input signal 552, which is an example of any of a ground signal at ground having zero voltage level (FIGS. 9 and 11), an analog signal received from resistor 252 (FIG. 10), non-inverting amplifier input signal 356 (FIG. 8), ground signal (FIG. 7), and an analog signal received from resistor 252 (FIG. 6).

Operational amplifier 550 also receives an inverting input signal 554, which is an example of any of an analog signal received from resistors 302 and 304 (FIG. 11), an analog signal received from resistor 254 (FIG. 10), an analog signal received from resistors 402 and 404 (FIG. 9), an analog signal received from resistors 352 and 354 (FIG. 8), an analog signal received from resistors 302 and 304 (FIG. 7), and an analog signal received from resistor 254 (FIG. 6). Operational amplifier 120 provides a gain to one of inverting input signal 554 and non-inverting input signal 552 to output an operational-amplifier output signal 556, which is an example of an analog signal output from operational amplifier 120. A power source, such as a voltage source, supplies a positive voltage level Vₛ, which is an example of Vₑ, to operational amplifier 550. Moreover, a power source, such as a voltage source, supplies a negative voltage level −Vₛ, which is an example of −V_{f}, to operational amplifier 550.

Any of transistors Q1-Q22 may saturate during operation of operational amplifier 550. It is noted that components of summation system 58, nonlinear transfer system 60, and weights 62 and 64 are made of a semiconductor, such as silicon or germanium. For example diodes 153 and 155 are manufactured from silicon, transistors Q1-Q22 are manufactured from silicon, resistors of operational amplifier 550 are manufactured from silicon, and resistors 254, 256, 302, 304, 352, 354, 402, 404, 454, and 456 are manufactured from silicon. Moreover, any of transistors Q1-Q22 may be turned on, switched on, or activated during operation of neuron 50. Additionally, any of transistors Q1-Q22 may be turned off or switched off during operation of neuron 50. Semiconductor saturation, such as saturation of any of transistors Q1-Q22, and semiconductor switching, such as switching either on or of, of any of transistors Q1-Q22, is performed by nonlinear transfer system 60 to generate a nonlinear transfer function piecewise. It is noted that in one embodiment, at least one of resistors 112, 114, 116, 118, 122, 124, 152, 156, 158, 252, 254, 302, 304, 352, 354, 402, 404, 454, 456, and resistors of operational amplifier 550 are made of a conductor instead of a semiconductor. It is also noted that in another embodiment, operational amplifier 550 may include other types of transistors, such as junction field effect transistors (JFETs) or metal oxide semiconductor FETs (MOSFETs).

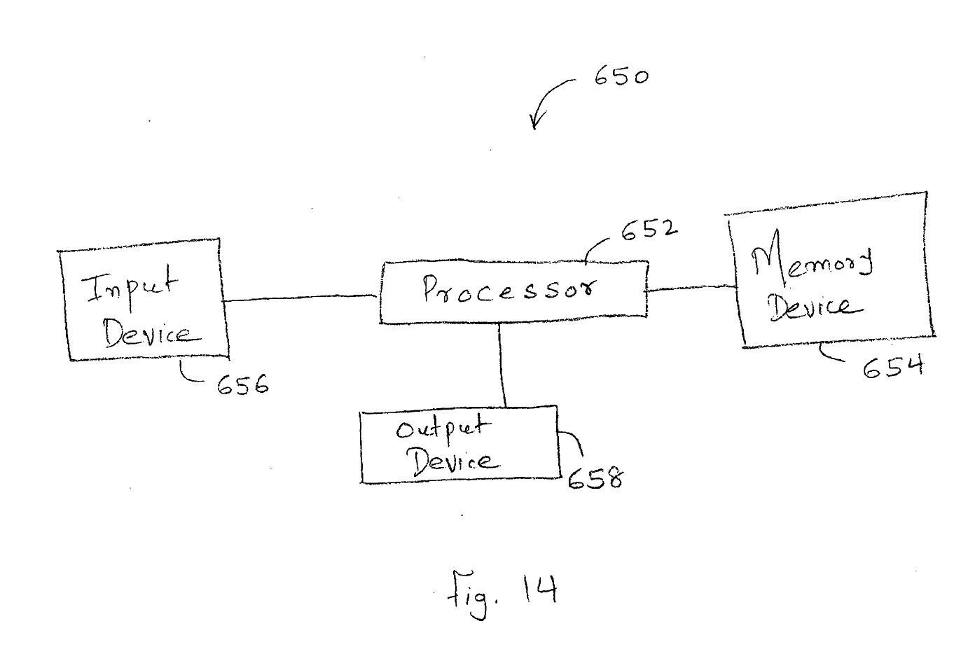

FIG. 13 is a circuit diagram of an embodiment of an artificial neural network system 600, which is an example of artificial neural network system 10. Artificial neural network 600 includes a bias 602, which is an example of a bias within set 24 of biases, a plurality of neurons 604, 606, 608, and 610 within a neural input layer 612, a plurality of neurons 614 and 616 within a neural hidden layer 618, and a plurality of neurons 620, 622, and 624 within a neural output layer 626. Neural input layer 612 is an example of neural input layer 12, neural hidden layer 618 is an example of neural hidden layer 14, and neural output layer 626 is an example of neural output layer 16. Artificial neural network system 600 categorizes as neural outputs a plurality of varieties of an Iris flower upon receiving measurements of four parts of the Iris flower as neural inputs.

FIG. 14 is a diagram of an embodiment of a system 650 for generating parameters of an artificial neural network system 10. System 650 includes a processor 652, a memory device 654, an input device 656, and an output device 658. Examples of the parameters include a resistance of any one of resistors 112, 114, 116, 118, 122, 124, 152, 156, 158, 252, 254, 302, 304, 352, 354, 402, 404, 454, and 456. Each neural input 52 and 54 can include an analog signal received from input device 656. In one embodiment, each neural input 52 and 54 includes an analog signal received from a sensor, such as a nanotech sensor, a temperature sensor, or a pressure sensor. Examples of the nanotech sensor include a chemical sensor and a biometric sensor. Other examples of the parameters include a plurality of resistances of at least two of resistors 112, 114, 116, 118, 122, 124, 152, 156, 158, 252, 254, 302, 304, 352, 354, 402, 404, 454, and 456. Examples of memory device 654 include a random access memory (RAM) and a read-only memory (ROM). Examples of input device 656 include a mouse and a keyboard. Examples of output device 658 include a cathode ray tube (CRT) and a liquid crystal display (LCD). Processor 652 receives at least one of a topology or layout of artificial neural network system 10, the gain of any of weights 62 and 64, and bias signal 56 from the user via input device 656. An example of the topology of artificial neural network system 10 includes a topology of neuron 50 and the topology of neuron 50 includes that neural inputs 52, 54, and a bias within set 24 of biases are connected to summation system 58, that summation system 58 is coupled to nonlinear transfer system 60, which is further coupled to weights 62 and 64. Another example of the topology of artificial neural network system 10 includes the topology of neuron 50 and the topology of neuron 50 includes that the neuron 50 includes weights 62 and 64.

Processor 652 executes a script language, such as a Ruby script or a Dylan script, upon receiving the at least one of the topology of artificial neural network system 10, the gain of any of weights 62 and 64, and bias signal 56 to generate a SPICE code that provides the parameters. For example, when the user provides the gain of non-inverting amplifier 102 to be 2.14 and a topology of non-inverting amplifier 102 to processor 652, processor 652 generates non-inverting amplifier 102 having a resistance of resistor 352 to be 100 k and a resistance of resistor 354 to be 114 k. As another example, when the user provides the gain of inverting amplifier 400 to be −2.14 and a topology of inverting amplifier 400 o processor 652, processor 652 generates inverting amplifier 400 having a resistance of resistor 402 to be 100 k, a resistance of resistor 404 to be 214 k. As yet another example, when the user provides the gain of VDNB 450 to be equal to 0.712 and a topology of VDNB 450 to processor 652, processor 652 generates VDNB 450 having a resistance of resistor 454 of voltage divider 452 to be 288 k, having a resistance of resistor 456 of voltage divider 452 of VDNB 450 to be 712 k, and having the same resistance of each of resistors 252 and 254. As yet another example, when the user provides the gain of VDIB 500 to be equal to −0.712 and a topology of VDIB 500 to processor 652, processor 652 generates VDIB 500 having a resistance of resistor 454 of voltage divider 452 of VDIB 500 to be equal to 288 k, having a resistance of resistor 456 of voltage divider 452 of VDIB 500 to be equal to 712 k, and having the same resistance of each of resistors 302 and 304. It is noted that resistances, such as 500 k or 600 k, of any of resistors 252, 254, 302, and 304 are input into memory device 654 by the user via input device 656.

Moreover, processor 652 includes a training program, such as, a software development kit (SDK) for Neuralware Predict™ or Neuralware Professional™ II/PLUS, that is provided a plurality of training neural inputs and training neural outputs by the user via input device 656. Processor 652 receives the training inputs and training outputs, creates a representation or topology of neural network system, including neuron 50, determines bias signal 56, and determines weights 62 and 64 based on the training inputs and outputs. For example, when the user provides a plurality of training neural inputs and outputs, processor 652, based on the SDK, determines that weight 62 is equal to 2.14 and that an artificial neural network system having weight 62 includes one neuron. In the example, based on weight 62 being equal to 2.14 and based on an artificial neural network including one neuron, processor 652 determines that the weight 62 includes non-inverting amplifier 350 with a resistance of resistor 352 to be 100 k, and a resistance of resistor 354 to be 114 k. As another example, when the user provides a plurality of training neural inputs and outputs, processor 652, based on the SDK, determines that weight 62 is equal to −0.712 and that an artificial neural network system having weight 62 includes one neuron. In the example, based on weight 62 being equal to −0.712 and based on an artificial neural network including one neuron, processor 652 determines that weight 62 includes VDIB 500 including voltage divider 452 having a resistance of resistor 454 to be 288 k and having a resistance of resistor 456 to be 712 k. The script language and the training program are stored in memory device 654 that may be a computer-readable medium, such as a floppy disk, a compact disc, or a magneto-optical disc.

The analog electrical circuits of FIGS. 3, 4, and 6-13 simulate an operation of artificial neural network system 10 by using at least one of a voltage level, a current level, a signal frequency, and a power level of an analog signal to represent an activation level. For example, neuron 50 provides neural outputs 66 and 68 or is activated when either a voltage level, a signal frequency, a current level, or a power level of an analog signal at node 162 is greater than zero. As another example, neuron 50 provides neural outputs 66 and 68 when either a voltage level, a current level, a signal frequency, or a power level of an analog signal at point 126 is greater than zero.

The analog electrical circuits of FIGS. 3, 4, and 6-13 simulate an operation of artificial neural network system 10 by using at least one of a set of voltage levels, a set of current levels, and a set of frequencies of a plurality of analog signals to represent a plurality of activation levels. For example, neuron 50 provides neural outputs 66 and 68 or is activated when either a power level, voltage level, a current level, or a signal frequency of an analog signal at node 162 is greater than zero and provides neural outputs 66 and 68 when either a voltage level, a current level, power level, and a signal frequency of an analog signal at point 126 is greater than zero.

The analog electrical circuits of FIGS. 3, 4, and 6-13 of artificial neural network system 10 uses a voltage level in place of a mathematical activation level, a summation of voltage levels of neural inputs 52 and 54 and bias signal 56 instead of a mathematical summation, saturated semiconductors in place of a mathematical transfer function, a combination of a buffer, an amplifier, and a voltage divider as weights instead of mathematical multipliers, and physical wires in place of the virtual mathematical connections between neurons. When a series of voltage levels are applied as inputs to any one of the analog electrical circuits of FIGS. 3, 4, and 6-13, the one of the analog electrical circuits generates corresponding output voltage levels simultaneously with the inputs. A speed of artificial neural network system 10 depends on a plurality of switching speeds of a plurality of semiconductor devices, such as transistors Q1-Q22. The analog electrical circuits of FIGS. 3, 4, and 6-13 utilize a minimal amount of power to drive a plurality of active components, such as operational amplifier 120, diodes 153 and 155, and transistors Q1-Q22, which can be etched into a microchip or an integrated circuit. Moreover, the active components and resistors 112, 114, 116, 118, 122, 124, 152, 156, 158, 252, 254, 302, 304, 352, 354, 402, 404, 454, and 456 are low cost components.

By creating a physically-small, low-power, low-cost artificial neural network system 10 integrated into a chip, artificial neural network system 10 may be integrated into a plurality of small devices. The analog electrical circuits of FIGS. 3, 4, and 6-13 allow, for example, an incorporation of biometrics into handheld devices with no processor overhead, an incorporation of chemical-detection capabilities incorporated into either handheld or hidden security devices, and an incorporation of neural brain deployment in small robots. Additionally, the analog electrical circuits of FIGS. 3, 4, and 6-13 facilitate image recognition, automaton or robot control, and can be used in diagnostic medicine and network security.

Artificial neural network systems and methods for creating artificial neural network systems described herein address a plurality of issues associated with computing capacity in a plurality of “fuzzy” logic applications by providing analog electrical circuits of FIGS. 3, 4, and 6-13 instead of either a desktop of a laptop computer.

Artificial neural network system 10 may be integrated into a microchip that is physically attached to the user. Artificial neural network system 10 receives a signal sensed by a sensor, processes the signal, and provides an output to the user without a need to transmit the signal from artificial neural network system 10 to a remote location including a processor that can process the signal. Moreover, artificial neural network system 10 may process the signal from the sensor in a lower number of clock cycles than a number of clock cycles used by the processor to process the signal. Additionally, artificial neural network system 10 weighs less than a weight of either a desktop of a laptop computer that includes a memory device, a processor, a basic input/output system, and other elements and that can process the signal from the sensor. Moreover, operational amplifier 120 and diodes 153 and 155 included within artificial neural network system 10 consume a lesser amount of power compared to an amount of power consumed by either a desktop of a laptop computer. The lesser amount of power results in a lighter battery that powers artificial neural network system 10 than a weight of a battery that provides power to either a desktop or a laptop computer. It is noted that in one embodiment, Vₐ is equal to V_{c}, which is equal to Vₑ and −V_{b} is equal to −V_{d}, which is equal to −V_{f}. In another embodiment, Vₐ is not equal to at least one of V_{c} and Vₑ, and −V_{b} is not equal to at least one of −V_{d} and −V_{f}.

While the invention has been described in terms of various specific embodiments, those skilled in the art will recognize that the invention can be practiced with modification within the spirit and scope of the claims.

1. A system comprising an artificial neural network including a plurality of neurons, wherein one of said neurons includes an analog electrical circuit and said neurons are interconnected.

2. A system in accordance with claim 1, wherein said analog electrical circuit includes an operational amplifier.

3. A system in accordance with claim 1, wherein one of said neurons includes an operational amplifier.

4. A system in accordance with claim 1, wherein one of said neurons includes an operational amplifier, wherein said operational amplifier includes a transistor.

5. A system in accordance with claim 1, wherein one of said neurons includes a weight, wherein the weight changes based on a configuration of an operational amplifier.

6. A system in accordance with claim 1, wherein one of said neurons includes a nonlinear transfer system that provides a nonlinear output and includes an operational amplifier.

7. A system in accordance with claim 1, wherein one of said neurons includes a summation system, wherein said summation system is configured to sum a plurality of analog signals and includes an operational amplifier.

8. A system in accordance with claim 1, wherein said artificial neural network uses at least one of a voltage level, a current level, a signal frequency, or an electrical property other than the voltage level, the current level, and the signal frequency to represent an activation level of the artificial neural network.

9. A system in accordance with claim 1, wherein said artificial neural network includes a semiconductor configured to saturate to generate a nonlinear transfer function.

10. A system in accordance with claim 1, wherein said artificial neural network includes a semiconductor configured to switch to generate a nonlinear transfer function.

11. A neuron comprising an analog electrical circuit.

12. A neuron in accordance with claim 11, wherein said analog electrical circuit includes an operational amplifier.

13. A neuron in accordance with claim 11, wherein said neuron includes an operational amplifier.

14. A method comprising generating an artificial neural network including a plurality of neurons interconnected to each other, wherein one of said neurons includes an analog electrical circuit.

15. A method in accordance with claim 14, wherein said analog electrical circuit includes an operational amplifier.

16. A method in accordance with claim 14, wherein one of said neurons includes an operational amplifier.

17. A processor executing a computer program, said processor configured to:
receive a topography of an artificial neural network;
receive a weight of a neuron within the artificial neural network; and
generate a plurality of parameters based on the weight and the topography.

18. A processor in accordance with claim 15, wherein the parameters include a resistance.

19. A processor in accordance with claim 15, wherein the parameters include a resistance within one of an inverting amplifier, a non-inverting amplifier, a combination of a voltage divider and an inverting buffer, and a combination of a voltage divider and a non-inverting buffer.

20. A processor for executing a computer program, said processor configured to:
receive a training neural input;
receive a training neural output;
calculate a topography of an artificial neural network, a weight of the artificial neural network, and a plurality of parameters of the artificial neural network from the training neural input and the training neural output.

21. A processor in accordance with claim 18, wherein the parameters include a resistance.

22. A processor in accordance with claim 18, wherein the parameters include a resistance within one of an inverting amplifier, a non-inverting amplifier, a combination of a voltage divider and an inverting buffer, and a combination of a voltage divider and a non-inverting buffer.
